(19) United States
(12) Patent Application Publication
(10) Pub. No.: US 2013/0292375 A1
(43) Pub. Date: Nov. 7, 2013

(54) MULTI-TEMP SQUARE TRAY DESIGN

(71) Applicant: H.J. HEINZ COMPANY, (US)

(72) Inventors: Daniel C. JACKSON, Wexford, PA (US); Christopher P. ROWOTH, Cranberry Township, PA (US); George Ikuya NUKUTO, Wexford, PA (US); Katherine A. Smith, Pittsburgh, PA (US); Elizabeth A. Ritchey, Cranberry Township, PA (US); Brian P. Carman, Wexford, PA (US); William J. Rodgers, Cranberry Township, PA (US); Brian Huber, Pittsburg, PA (US); Amber F. Koehler, Pittsburgh, PA (US)

(21) Appl. No.: 13/863,653

(22) Filed: Apr. 16, 2013

Related U.S. Application Data
(63) Continuation-in-part of application No. 12/982,486, filed on Dec. 30, 2010, now Pat. No. 8,445,043.
(60) Provisional application No. 61/291,161, filed on Dec. 30, 2009.

(51) Int. Cl. H05B 6/64; F24C 7/02

(52) U.S. Cl. CPC H05B 6/6408; F24C 7/02
USPC 219/729; 99/339; 53/467

(57) ABSTRACT

A substantially square multi-temperature and multi-texture frozen food microwave heating tray with Y shaped, flex stabilizing dividers, includes a first integral compartment defined by at least one sidewall and an upwardly convex bottom, and two additional integral compartments defined by at least one sidewall and a bottom and comprising a microwave energy access modulating structure for at least one of the compartments.

### CROSS-REFERENCE TO RELATED APPLICATIONS

This application is a continuation-in-part of U.S. patent application Ser. No. 12/982,486, filed Dec. 30, 2010, which is based on, and claims the benefit of, U.S. Provisional Application Ser. No. 61/291,161, filed Dec. 30, 2009, the entire contents of both applications which are hereby incorporated herein by this reference thereto.

### TECHNICAL FIELD

The field of art to which this invention generally pertains is microwave packaging containing frozen food products

### BACKGROUND

Microwave heating trays often include adjacent compartments for heating more than one quantity of food at a time. Often, different foods in different compartments heat unevenly resulting in hot and cold spots within each quantity of food as a result of the varying density of the foods, water content, and other such factors. In addition, since all compartments are subjected to the same incident microwave energy, some food may be overheated when heated by microwave along with other foods. Moreover, many microwave ovens often include a glass tray that holds food off the floor of the microwave oven. However, not wishing to be bound by any particular theory, the glass tray may absorb some heat or energy from the food, thereby potentially lengthening heating times and further causing uneven heating of foods.

Multi-compartment heating trays for microwavable foods are shown, for example, in U.S. Pat. No. 7,476,830. The packaging includes multiple compartments for separating food items and one or more microwave energy interactive materials.

The present invention meets the challenges described above, with additional benefits as described below.

### BRIEF SUMMARY

A microwave heating support is described including a tray having a smoothly contoured, substantially square peripheral shape, substantially free of sharp corners, having a Y shaped compartment divider, and formed of a microwave safe plastic or paper material. The tray includes a first integral compartment defined by at least one sidewall and an upwardly convex bottom; a second integral compartment defined by at least one sidewall and a generally planar bottom; and a third integral compartment defined by at least one sidewall and a generally planar bottom. The integral compartments are spaced apart from each other by a distance sufficient to provide thermal insulation between the compartments, the shape and spacing of the compartments resulting in uniform heating within each individual compartment, and the Y shaped compartment divider providing flex stability to the tray.

Embodiments of the invention include: the microwave heating support described above, where at least one of the compartments has a recessed sealing surface; the microwave heating support described above, where at least one of the compartments further includes a microwave energy limiting structure; the microwave heating support described above where the microwave energy limiting structure includes a material of foil, microwave absorbing material, microwave transmitting material, microwave reflecting material, or combinations thereof; the microwave heating support described above, where the microwave energy limiting structure includes at least one opening; the microwave heating support described above where the first integral compartment contains a first quantity of food, the second integral compartment contains a second quantity of food, and the third integral compartment contains a third quantity of food; the microwave heating support described above where the first quantity of food, the second quantity of food and the third quantity of food have different densities and/or heating characteristics; the microwave heating support described above where at least one of the first quantity of food, the second quantity of food and the third quantity of food is an individually quick frozen food item; the microwave heating support described above where at least one food item is contained in the recessed sealing surface containing compartment; the microwave heating support described above where the recessed sealing surface containing compartment is sealed with a metal foil or plastic lid; the microwave heating support described above where the lid contains a pull-tab; the microwave heating support described above where the lid is aluminum foil or polyester lid stock; the microwave heating support described above where the upwardly convex bottom has a domed central portion and a lower, outer edge and the food located at the lower, outer edge is thicker than the food located at the domed central portion; the microwave heating support described above where the domed central portion is offset from the lower, outer edge by about 0.1 inch to about 1.0 inch; the microwave heating support described above where adjacent portions of the sidewalls of the compartments diverge in a downward direction; the microwave heating support described above where the microwave energy limiting structure is removable; the microwave heating support described above further including lidding material covering at least the first, second and third compartments, and being sealed to the tray so as to substantially isolate the first, second and third compartments from one another; the microwave heating support described above where the lidding material is sealed to the tray substantially along the smoothly contoured peripheral shape thereof and offset from the periphery toward the center of the heating support.

Other embodiments include: a method of packaging multiple foods for microwave heating to different temperatures including the steps of providing a microwavable plastic or paper tray having a substantially square peripheral shape, substantially free of sharp internal or external corners, having a Y shaped compartment divider, the tray including a first integral compartment defined by at least one sidewall and a generally planar bottom; a second integral compartment defined by at least one sidewall and an upwardly convex bottom, and a third integral compartment defined by at least one sidewall and a generally planar bottom, where the integral compartments are spaced apart from each other by a distance sufficient to provide thermal insulation between the compartments, the shape and spacing of the compartments resulting in uniform heating within each individual compartment, and the Y shaped compartment divider providing flex stability to the tray, placing a first food in the first integral compartment of the tray so that upon exposure to microwave energy for a predetermined time period the temperature of the first food reaches a corresponding first temperature; placing a second food in the second integral compartment of the tray such that the second food has a greater thickness at peripheral portions thereof than at central portions thereof, so that upon exposure to microwave energy for a predetermined time period the temperature of the second food reaches a corresponding second temperature which is different than the first temperature; and placing a third food in the third integral compartment of the tray so that upon exposure to microwave energy for a predetermined time period the temperature of the third food reaches a corresponding third temperature which is different than the first temperature, at least partially covering at least one of the first, second and third compartments with a microwave modulating structure, so that upon exposure to the microwave energy for the predetermined time period the temperature of the second and third foods reach corresponding second and third temperatures which are different than the first temperature; and covering at least one of the first, second and third compartments with a substantially microwave transparent structure; the method described above where the microwave modulating structure reduces the microwave energy entering the compartment by at least about 25%; the method described above where at least one of the first, second and third foods is a quick frozen food item; the method described above where the compartment has a recessed sealing surface; the method described above where the recessed sealing surface containing compartment is sealed with a metal foil or plastic lid; the method described above where the lid contains a pull-tab; the method described above where the lid is aluminum foil or polyester lid stock.

These, and additional embodiments, will be apparent from the following descriptions.

### BRIEF DESCRIPTION OF THE DRAWINGS

Many objects and advantages of this invention will be apparent to those skilled in the art when this description is read in conjunction with the appended drawings wherein like reference numerals have been applied to like elements and wherein:

FIG. 1 is a top view of a microwave tray including three compartments.

FIG. 2 is a perspective view of a microwave tray including three compartments and microwave energy limiting structure.

FIG. 3 is a perspective view of a microwave tray including three compartments and a lid.

FIG. 4 is a perspective view of another microwave tray with three compartments.

FIG. 5 is a plan view of the microwave tray of FIG. 4.

FIG. 6 is an end view of the microwave tray of FIG. 4 with a portion broken away to show the shape of the bottom.

FIG. 7 is a perspective view of the yet another microwave tray having three compartments.

FIG. 8 is a plan view of the tray of FIG. 7.

FIG. 9 is a side view of the tray of FIG. 7.

FIG. 10 is a cross-sectional view taken along the line 24-24 of FIG. 8.

FIG. 11 is a cross-sectional view taken along the line 25-25 of FIG. 8.

FIG. 12 is a top view of a pull tab embodiment

FIG. 13 is a top view of the tray

FIG. 14 is a top view perspective of the tray

FIG. 15 is a top view perspective of the tray including the muffin embodiment

### DETAILED DESCRIPTION

The microwave heating tray includes first, second and third integral compartments spaced from each other by lands. The lands thermally insulate the compartments from each other and contribute to even heating of the foods contained in their respective compartments. The first integral compartment is preferably defined by at least one sidewall and an upwardly convex bottom. That convex bottom functions to elevate at least a portion of the quantity of food contained in the first integral compartment above the floor of a microwave oven. Moreover, the associated food item is thinner in the central area above the convex bottom and thicker at the edges adjacent the compartment sidewall. This arrangement is helpful in providing a more uniform temperature for the associated food item in that particular compartment. By elevating at least a portion of the food within a microwave oven above the bottom or floor of the oven, the food may heat faster and more evenly. Microwave energy in the oven is generally reflected from the internal surfaces of the oven, including the floor—so positioning the food away from the surface places the food at a location where the amplitude of the microwaves is higher than at a reflection point such as the internal surface. The second and or third integral compartment may include microwave energy limiting structure operable to reduce and/or control exposure of the second quantity of food to microwave energy.

Each compartment is defined by at least one corresponding sidewall 16, 17 and a corresponding bottom 18, 19. Preferably, the compartments 12, 14 and 55 are separated by a land 22 so that the compartments are thermally isolated from each other. The land 22 separates generally parallel portions of the adjacent to portions of sidewalls 16, 17.

Preferably, the microwave heating tray 10 has a smoothly contoured peripheral shape. By way of example, the smoothly contoured peripheral shape for the microwave heating tray 10 can be square. round, oval, or elliptical. Also the compartments both internally and externally have smoothly contoured peripheral shapes substantially free of sharp corners. Preferably, when the compartments 12, 14 and 55 or the square tray include corners, the corners are rounded corners 20. Rounded corners of the compartments 12, 14 and 55 and the rounded corners of the square heating tray 10 help prevent overheating of food as compared to compartments and trays having sharp corners. In addition, the rounded corners of the microwave heating tray 10 allows for easier molding of means for limiting microwave energy access, when used, around the quantity of food contained within the compartments 12, 14 and 55.

In one embodiment, the first compartment 14 has a volume ranging from about 20 cubic inches to about 30 cubic inches and the second and third compartments have a smaller volume ranging from about 6 cubic inches to about 8 cubic inches. For example, the first compartment 14 can have a volume of about 27 cubic inches and the second compartment and third about 6 can have a volume of about 7 cubic inches. Also preferably, the compartments can be about 1 inch to about 1.5 inch deep. However, the first compartment 14, having the upwardly concave bottom will have varying depths throughout the compartment. Also, typically, the first compartment 14 has a width (W) ranging from about 4 inches to about 5 inches, more typically about 4.6 inches to about 4.7 inches, and a length (L) about 6 to about 7 inches. Moreover, the second and third compartments 12 and 55 have widths ranging from about 2.5 inches to about 4 inches and a length about 3 to about 4 inches. Both the first compartment and the second compartment 12, 14 have a length and width ranging from about 5 inches to about 6 inches. Typically, the length of the first and second compartments 12, 14 at the longest portion thereof is about the same as the length of the land 22.

In one embodiment, the microwave heating tray 10 may be formed of a conventional microwave-safe material, such as heat resistant plastic or paper stock, that is not subject to scorching, burning, melting, deformation, and the like when exposed to microwave heating energy. The material used to form the microwave heating tray must also be safe for use with foods. Microwave safe materials can be selected, for example, from the group consisting of polyethylene terephthalate (PET), crystalline polyethylene terephthalate (CPET), polypropylene, high-heat styrenic copolymers such as DYLARK®, mineral filled polypropylene, molded pulp, pressed paper, high density polyethylene (HDPE), and/or combinations thereof. Moreover, the material used to form the microwave heating tray 10 is thick enough to form a substantially rigid tray.

In one embodiment, the compartments are spaced apart from each other by the land 22. The land 22 has a width w ranging from about 0.125 inch to about 0.75 inch, more preferably about 0.25 inch to about 0.5 inch. Preferably, the land 22 has a uniform width across the length thereof. By spacing apart the compartments, the compartments 12, 14 and 55 are thermally insulated from one another so that different heating temperatures can be achieved in each compartment 12, 14, and 55 if desired. Compartments that are positioned too closely do not sufficiently insulate the first quantity of food in the first integral compartment from the second quantity of food in the second compartment and the third quantity of food in the third compartment which can result in one or more quantities of foods that are at least partially overheated and/or under heated.

As shown in the figures, at least one compartment includes at least one sidewall 17 and an upwardly convex bottom 19 defined by a dome sidewall 50. The upwardly convex bottom 19 includes a domed central portion 24 surrounded by a lower, outer edge 26. Preferably, the domed central portion 24 is located substantially in the center of the first integral compartment 14 because food located in the center typically heats up more slowly than food on the outer periphery. Thus, by locating the domed central portion 24 centrally, the portion of the quantity of food in the center of the compartment 14 will be thinner and will heat faster so that the food in the center and the food located at the edge reaches about the same temperature at about the same time. In addition, the domed central portion 24 elevates the food above the glass bottom of the microwave oven so as to prevent heat energy transfer to the glass. Warm air trapped underneath the domed central portion 24 during heating also insulates the food from the glass thereby preventing loss of heat and allowing for faster heating of the food located in the center of the first integral compartment 14.

Also in one embodiment, the food located at the edges of first compartment 14 is thinner than the food located at the domed central portion 24. For example, the thickness of the food at the edges of the first compartment 14 can range from about 0.5 inch to about 0.875 inch, and the thickness of the food at the center of the first compartment 14 can range from about 0.312 inch to about 0.5 inch when the dome has a height of about 0.3 inch. When the dome has a height of about 0.13 inch, the thickness of the food at the edges can range from about 0.438 inch to about 0.938 inch and the food at the center of the first compartment 14 can range from about 0.312 inch to 0.813 inch. When the dome has a height of about 0.47 inch, the thickness of the food at the edges can range from about 0.625 inch to about 1.06 inch and the food at the center of the first compartment 14 can range from about 0.312 inch to 0.625 inch.

In one embodiment, the domed central portion of the first integral compartment 14 can have a height of about 0.1 inch to about 1.0 inch, more preferably about 0.15 inch to about 0.75 inch, and most preferably about 0.2 inch to about 0.6 inch. As shown in the figures, for example, the domed central portion can have a height of about 0.47 inch and have a steep dome sidewall 50. Alternatively, for example, the domed central portion 24 can have a height of about 0.13 inch and can have gently sloped dome sidewall. Dome heights that are too small or too large can deter even heating throughout the first integral compartment 14 as described in greater detail below.

In one embodiment, adjacent portions of the sidewalls diverge in a downward direction. Alternatively, the adjacent portions of the sidewalls can be substantially parallel. The diverging sidewalls allow for efficient stacking and denesting of the trays during manufacture of the trays and filling of the trays. In contrast, substantially vertical sidewalls can deter in efficient stacking of the trays.

The first integral compartment 14 can contain a first quantity of a first food, the second integral compartment can contain a second quantity of a second food, and the third compartment can contain a third quantity of a third food. In a preferred embodiment, the first quantity of food and the second quantity of food and the third quantity of food are different types and/or quantities of foods with different densities and heating characteristics.

Preferably, the first quantity of food heats more slowly than the second and third quantities of food. Also preferably, the first, second and third quantities of food have different densities and heating characteristics so that the foods will all heat to a desirable temperature in about the same length of time and so that the available food types can be expanded in comparison to previously available combinations. Thus, one quantity of food may have a lower density and may heat faster. In one embodiment, one quantity of food can also be pelletized to lower the density thereof. In other embodiments, one quantity of food can be formed into cubes or a toroidal configuration so as to reduce the heating time needed to substantially uniformly heat that quantity of food 30. In an alternative embodiment, the quantity of foods can have different densities or heating characteristics.

For purposes of this disclosure, a “pellet” is intended to mean a small piece of a food ingredient. That pellet may be any regular or irregular shape including, for example and without limitation, generally spherical, generally circular disk, generally hemispherical, generally cubic, generally cylindrical, generally toroidal, generally planar, and the like. Moreover, the pellet preferably has a principal dimension which is substantially smaller than the maximum lateral dimension of an associated tray compartment, for example, less than about 25% of such maximum lateral dimension. Alternatively, the pellet preferably has a principal dimension which is smaller than the depth of an associated tray compartment. For purposes of this disclosure, the term “pelletized” means forming an ingredient into pellets.

Also in one embodiment, the ratio of the weights of the quantities of foods can be adjusted to regulate or control the final temperature of the respective quantities of food based on overall tray heating time. Thus, the ratio of chili to cornbread is about 75% to about 25% or about 3:1.

For example, the foods can be selected from the group consisting of bread products, soups, vegetables, meats, sandwiches, pizzas, sauces, dips, condiments, desserts, pastas, wraps, casserole type dishes, appetizers, such as chicken wings, nachos, egg rolls, and mozzarella sticks, seafood, rice, beans, cottage cheese, ice cream, custard, yogurt, fruit, salad, and/or combinations thereof.

In one embodiment, the microwave heating tray may include means for limiting microwave energy access. The means for limiting microwave energy access can be in the form of a top shield that at least partially blocks microwave energy from entering through a top of one of the compartments so as to reduce the heated temperature in that compartment. In one embodiment, a top shield on the compartment is flat material and may be incorporated in a film material which can also act as a lid. In other embodiments, the means for limiting microwave energy access can be formed as a single piece. In other embodiments, the means for limiting microwave energy access can be in multiple pieces. Larger pieces or thicknesses of material for limiting microwave energy access tend to result in a lower temperature of food. Thus, when a lower food temperature is desired, larger pieces or thicknesses for limiting microwave energy access can be used.

The added pieces for limiting microwave energy access to the compartments of the microwave heating tray can also include a bottom shield either in addition to or in place of a top shield on the compartment. In one embodiment, the bottom shield is formed to fit the compartment so as to at least partially cover the sidewalls and bottom of the compartment over which the bottom shield is applied.

When multiple shields are used, it can be important to maintain a distance of at least about 2 mm between the top shield and bottom shield so as to prevent arcing in the microwave oven. If the closest distance between the two shields is less than about 2 mm, a large electric potential may be created which could cause arcing.

In one embodiment, the microwave energy limiting access materials do not contain any holes, slits, and the like therein. In other embodiments, the microwave energy limiting access materials can include holes, slits, and the like therein. When used, the size and/or shape of the holes in the top shield and/or bottom shield can be modified to optimize heating of the quantity of food contained in the compartment being shielded. For example, the holes in the top and/or bottom shield can be shaped as circles, squares, rectangles, pentagons, triangles, quadrilaterals, elongate slots, and combinations thereof. Additionally, the holes in the bottom shield and/or top shield can vary in location and size in order to control the amount of microwave energy entering the compartment so as to further optimize temperature and heating time. Thus, the shape of the holes and/or slots can be chosen to optimize heating. In one embodiment, the holes may be circular holes which provide a consistent diameter throughout the means for limiting microwave energy access. As compared to rectangular holes, circular holes have a more easily controlled size when multiple holes are placed in the microwave energy limiting access materials. The placement of the holes may be selected as a function of where and how microwave energy should be focused within the shielded compartment. For example, the diameter of the hole can be at least about 2 mm to prevent arcing in the microwave.

In one embodiment, the microwave energy limiting access material may be removable from the microwave heating tray. For example, a microwave tray can include a top shield and a bottom shield. Both the top shield and the bottom shield can be removable from the microwave tray so the separate components may be recycled. When the bottom shield is removable, the bottom shield and the compartment can include a snap feature to secure the bottom shield to the bottom of the compartment. Alternatively, the bottom shield may be permanently attached to the tray. In yet another embodiment, the bottom shield may be semi-permanently affixed to the microwave tray, for example, by a microwave safe adhesive.

The microwave access limiting material can include a material selected from the group consisting of foil, microwave absorbing material, microwave transmitting material, microwave reflecting material, and combinations thereof. In one embodiment, the foil is aluminum foil. Typically, when using a foil shield, the foil is not laminated, but can be, to a polymeric material. Also typically, the microwave energy access limiting material is a passive microwave shield that does not include microwave energy interactive elements. Typically, the microwave energy access limiting material reduces the microwave energy entering the particular compartment shielded by at least about 25%.

In use, the combination of the microwave energy access limiting material, the upwardly convex bottom of the first integral compartment and the land separating the compartments act together to shield, separate and evenly distribute heat throughout the quantities of food contained in each compartment. The microwave energy access limiting material at least partially prevents microwave energy from reaching the quantity of food so as to avoid overheating or maintain a cooler temperature as compared to an unshielded quantity of food. The separation between the compartments acts to thermally insulate each compartment from the other so as to allow for different heating temperatures in each compartment. Finally, the upwardly convex bottom in the first integral compartment causes food in the center of the compartment to heat more quickly so that the food in the first integral compartment is heated substantially uniformly throughout.

A method for packaging multiple foods for microwave heating to different temperatures includes providing a microwave tray having a separated by a land as described. The first integral compartment is defined by at least one sidewall and an upwardly convex bottom and the second and third integral compartments defined by at least one sidewall and a bottom. A first food is placed in the first integral compartment of the tray such that the first food has a greater thickness at peripheral portions thereof than at central portions thereof. Thus, upon exposure to microwave energy the temperature of the first food is substantially even throughout the first food. A second food is placed in the second integral compartment, and may be at least partially covered with a means for limiting microwave energy access, and a third food placed in the third compartment. Upon exposure to microwave energy, the second food reaches a lower temperature than the first and third foods due to the use of the microwave energy access limiting material. Typically, the microwave energy access limiting material reduces the microwave energy entering the second integral compartment by at least about 25%. In one embodiment, the foods can be pelletized to lower or adjust the densities thereof.

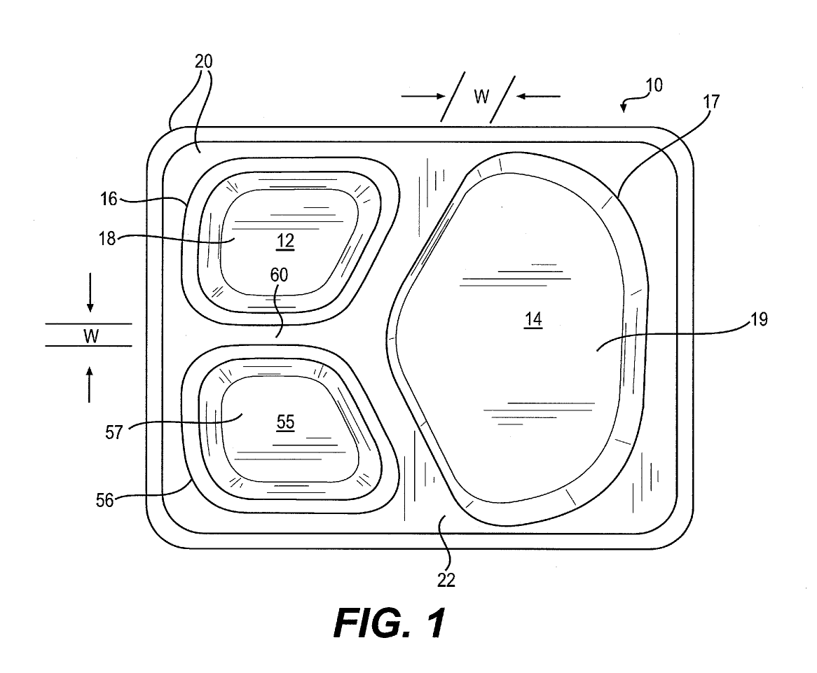

FIG. 1, shows a microwave heating tray 10 includes a first integral compartment 14, a second integral compartment 12, and a third integral compartment 55. Each compartment is defined by at least one corresponding sidewall 17, 16, 56 and a corresponding bottom 19, 18, 57.

The first compartment 14 is separated from the second and third compartments 12, 55 by a land 22 so that the first integral compartment 14 is thermally isolated from the first and second integral compartments 12, 55. Also preferably, the second compartment 12 is separated from the third compartment 55 by a second land 60. Typically, the second land has a width w′ that is sufficient to thermally isolate the second compartment 12 from the third compartment 55.Typically, the width w′ of the second land 60 and the width w of the first land 22 range from about 0.125 inch to about 0.75 inch, more preferably about 0.4 inch to about 0.6 inch. Preferably, the land 22 has a uniform transverse width substantially throughout the length thereof. In addition to the land characteristics, the seal between the lidding material and the tray is also important to maintenance of different temperatures in different compartments. To this end, it should be noted that when lidding material is applied to the tray, after the tray compartments have been filled with edible products, the lid is sealed to the tray not only around the peripheral edge but also along the lands between adjacent compartments 12, 14, 55. That sealing operation isolates each compartment 12, 14, 55 from each of the other compartments 12, 14, 55.

Also typically, each of the first, second, and third compartments 12, 14, 55 may contain a different food, although two or more of compartments 12, 14, 55 can contain the same food. Preferably, the foods contained in the first, second, and third compartments 12, 14, 55 have different densities and/or heating characteristics (e.g., dielectric and thermal properties).

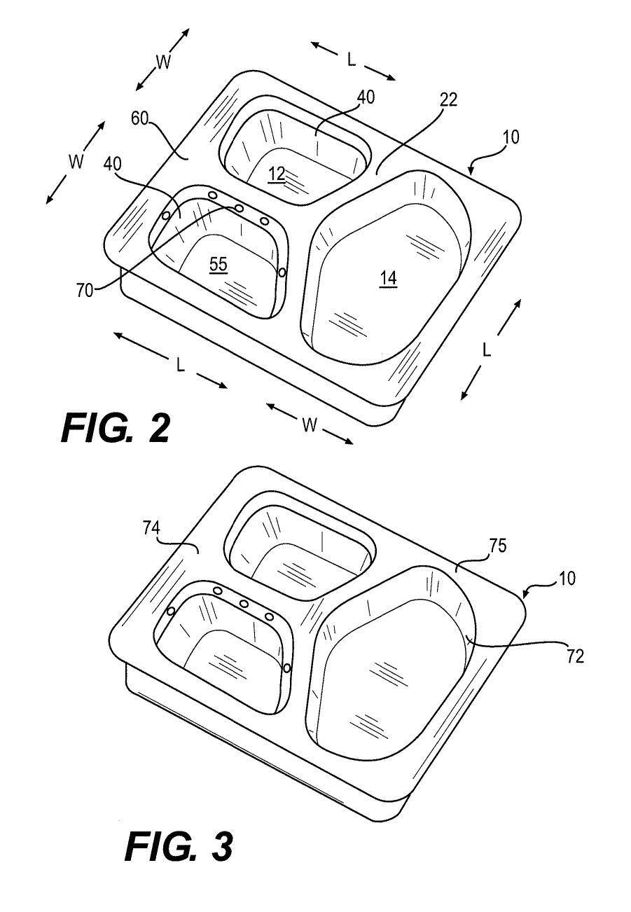

As shown in FIG. 2, the second compartment 12 and the third compartment 55 can include a microwave energy access limiting material 40 for limiting microwave energy access to the second integral compartment 12 and to the third integral compartment of the microwave heating tray 10. In one embodiment, the second and third compartments 12, 55 have different amounts of coverage of material for limiting microwave access. For example, as shown in FIG. 2, the microwave energy access limiting material for limiting microwave energy access 40 within the second compartment 12 does not include holes therein, while the microwave energy access limiting material for limiting microwave energy access 40 within the third compartment 55 does include holes 70 so as to allow more microwave energy to enter the third compartment 55 than the second compartment 12. Moreover, the microwave energy access limiting material for limiting microwave energy access 40 within the third compartment 55 can cover only the sides and a portion of the bottom of the compartment, while the second compartment 12 can include microwave energy access limiting material for limiting microwave energy access 40 on the sidewalls and bottom thereof. Thus, more microwave energy is able to enter the third compartment 55 than the second compartment 12. In one embodiment, microwave energy access limiting material for limiting microwave energy access 40 is located on an inner surface of the second and third compartments 12, 55. In an alternative embodiment, the microwave energy access limiting material for limiting microwave energy access 40 is located on an exterior surface of the compartment. In an alternative embodiment, the second and third compartments 12, 55 include the same amount of coverage of microwave energy access limiting material for limiting microwave energy access.

The particular location and amount of shielding used for any particular combination of foods will depend on the desired temperature for each food of the combination. Accordingly, it is within the scope of this invention, for example and without limitation, that only one compartment is shielded, that all compartments are shielded, that the amount of shielding is different for each of the compartments, that the amount of shielding is the same for two or more compartments, and the like.

As shown in FIG. 3, the microwave heating tray 10 can also include a removable lid 75. The portion of the lid 74, which covers the second and third compartments, can be formed of the material used to form the microwave energy access limiting material for limiting microwave energy access. In addition, the portion of the lid 72 used to cover the first compartment can be formed of a clear plastic material. Thus, the lid 75 can be formed to at least partially prevent microwave energy from entering one or more compartments of the tray 10. In other embodiments, the lid 74 can be formed entirely of the material used to form the microwave energy access limiting material for limited microwave energy access or of a clear plastic film depending upon the amount of microwave energy desired to enter each compartment. It is to be understood, that the lid material may be constructed and arranged such that the shielding aspects of the material have holes and/or slits as described above, while the lid material itself is continuous. For example, where the lid material is a composite of two or more layers, one layer may be continuous while a second layer containing microwave shielding material may have holes and/or slots for energy control.

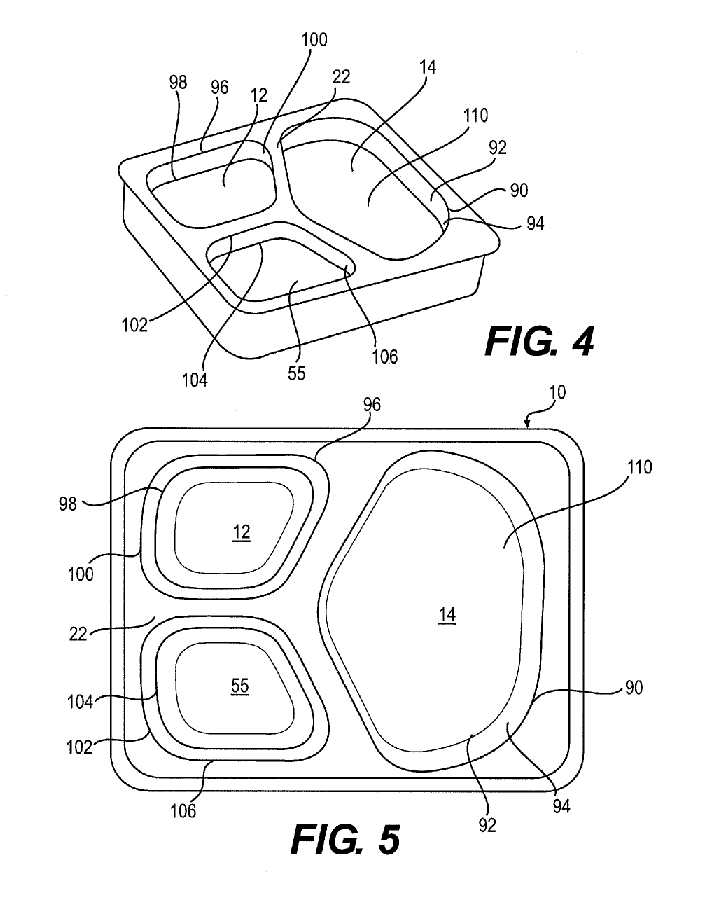

Another embodiment of the three compartment tray (see FIG. 4) is similar in size and proportion to the embodiment of the three compartment tray in FIG. 1, but has some further refinements. More particularly, the first or primary compartment 14 approximates a semicircle when viewed from above (see FIG. 5). Between the flange surrounding the first compartment 14, a top chamfer or top fillet 90 is provided. Similarly, at the bottom of the sidewall 94, a bottom fillet 92 surrounds the bottom 110 of the first compartment. Extending between the top fillet 90 and the bottom fillet 92 is the side wall 94 of the first compartment 14.

Similarly, the second compartment includes a top chamfer or top fillet 96 surrounding the second compartment and joining the flange to the second compartment side wall 100. At the bottom of the second compartment side wall 100, a fillet 98 extends between that side wall 100 and the substantially flat or generally planar bottom of the second compartment. The second compartment 12, viewed from the top, approximates a quarter-circle, or pie-shaped configuration.

Similarly, the third compartment 55 also includes a top chamfer or top fillet 102 surrounding the third compartment and joining the top flange to the side wall 106 of the third compartment. The side wall 106 extends from the top fillet to a bottom fillet 104 which surrounds the substantially flat or generally planar bottom of the third compartment. Like the second compartment 12, the third compartment may also approximate a quarter-circle or a pie-shaped configuration.

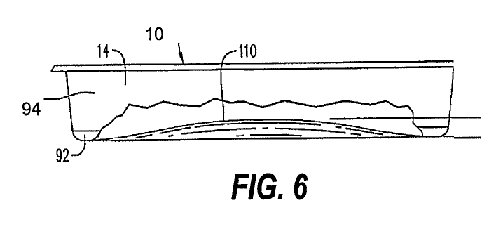

The bottom 110 of the first compartment 14 is curved upwardly into the chamber of the first compartment 14 such that a maximum elevation occurs in the central area of the bottom 110. When viewed in a generally longitudinal cross section, the bottom 110 is preferably curved so as to be convex upwardly from the bottom edge of the surrounding sidewall 94. Moreover, when viewed in a transverse cross section (see FIG. 6), the bottom 110 of the first compartment is curved upwardly into the chamber of the first compartment. Again, the bottom 110 is convex upwardly from the bottom edge of the surrounding sidewall 94 when seen in transverse cross section.

The height h of the domed portion of the bottom 110, preferably is in the range of about 20% to about 35% of the depth D of the first compartment 14. Preferably, the height h is about 25% of the depth D. As discussed above, the domed feature promotes uniform heating of a food product positioned in the first compartment 14.

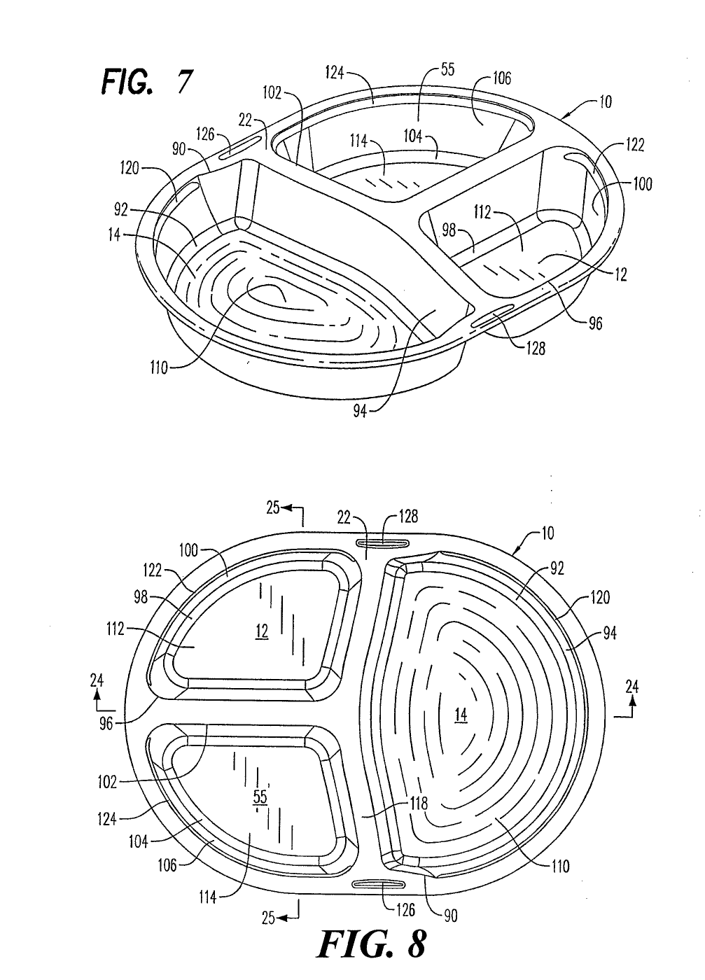

Yet another embodiment of the three compartment tray 10 (see FIG. 7) includes a first compartment 14, a second compartment 12, and a third compartment each having features as described above. This embodiment, however, includes a number of features that function to increase rigidity of the tray 10 and improve handling characteristics of the tray 10. These features include a non-linear transverse flange 118, a pair of elongate handles 126, 128, and a recessed edge 120, 122, 124 partially surrounding at least one of the compartments.

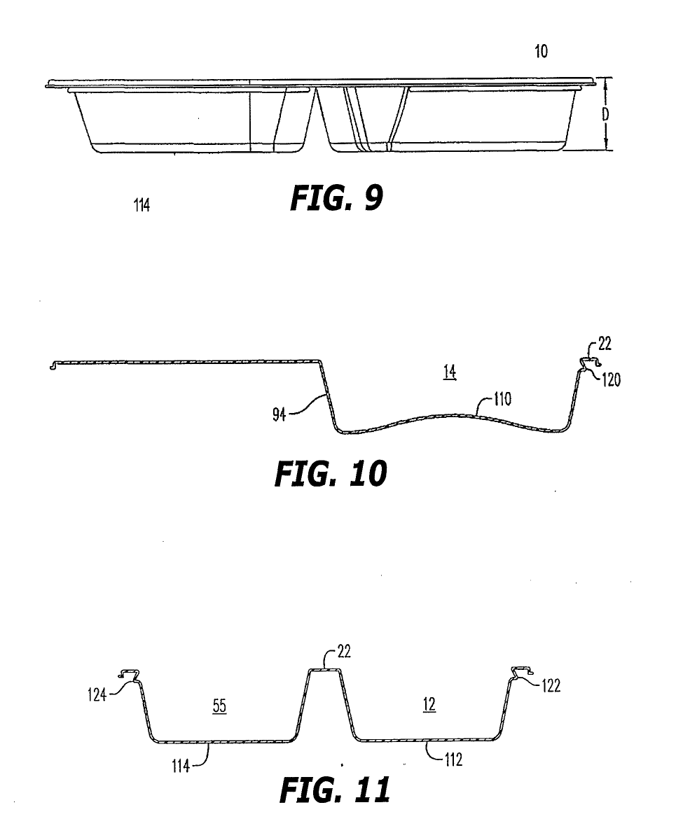

The non-linear transverse flange 118 (see FIGS. 8 and 9) may include a pair of substantially straight portions which are angled relative to one another. Preferably the straight portions are symmetrically disposed relative to the longitudinal axis of the tray 10. Preferably, the non-linear transverse flange 118 extends away from the center of the first compartment 14. If desired, the non-linear transverse flange could also be curved or generally arcuate. The offset measured between a line joining the ends of the transverse flange 118 and the greatest deviation of the edge of that flange and that line operates to stiffen the tray 10 against bending in the vertical plane containing the longitudinal axis. The greater that deviation, the greater the stiffening effect. Together with the longitudinal flange separating the other two compartments 12 and 55, the flange provides a Y shaped compartment divider.

The pair of handles 126, 128 can be substantially parallel to one another and to the longitudinal axis of the tray 10. If present, each handle 126, 128 can be longer than the width of the flange between the adjacent compartments of the tray. In this way, the handles 126, 128 function to stiffen the edges of the tray 10 at the corresponding ends of the transverse flange 118.

Additional stiffening of the tray 10 may be accomplished by including a recessed edge adjacent to the flange and at least partially surrounding at least one of the compartments. More particularly, the first compartment 14 may include a recessed edge 120 extending substantially around the compartment and substantially coextensive with the arcuately shaped portion or curved portion of the side wall 94. That recessed edge 120 (see FIGS. 10 and 11) cooperates with surface of the flange 22 to define a substantially C-shaped cross section for the flange 22 on the external periphery of the first compartment 14. That C-shaped cross section is stiffer against deflection out of the plane of the flange 22 than a design without such a cross-sectional configuration.

Similarly, one or more of the second compartment 12 and the third compartment 55 may include a corresponding recessed edge 122, 124 (see FIG. 11). As with the first compartment 14, the recessed edges 122, 124 are substantially coextensive with the arcuate or curved portion of the corresponding compartment 12, 55, and can act as stacking features, to keep the trays separated. Furthermore, the recessed edges 122, 124 can provide the same functionality as the recessed edge 120 discussed above in connection with the first compartment 14.

Preferably, the food products or ingredients selected for use with the microwavable tray described above packaged are individually quick frozen (IQF) products. More particularly, sauces, starches, vegetables, fruits, proteins, and dairy products may be used in the individually quick frozen form. The individually quick frozen products are available, for example, in the form of small cubes, generally spherical particles having a diameter of about one inch, generally hemispherical particles having a diameter of about one inch, as well as other geometric shapes. In any particular compartment of the microwavable tray, combinations of individually quick frozen ingredients may be used. As a result, for example and without limitation, it is possible to provide sauces mixed with starches, sauces mixed with vegetables, sauces mixed with proteins, sauces mixed with dairy products, vegetables mixed with starches, vegetables mixed with proteins, and the like. It should be noted that the individually quick frozen ingredients need not be mixed, but may be provided in layers such that sauces, for example, may be introduced as toppings. In short, use of individually quick frozen ingredients expands the possible range of culinary combinations possible in microwavable packaged foods.

In addition to the flexibility of potential culinary combinations possible, individually quick frozen ingredients introduce further benefits to the microwavable meals possible with the present disclosure. For example, individually quick frozen ingredients function to decrease the amount of cooking time necessary for preparing a microwavable meal. While the specific mechanism is not fully understood at the present time, individually quick frozen may aid the speed with which selected food ingredients reach a desired temperature because the individually quick frozen ingredients have lower density, greater surface area, smaller depth, and tend to heat more rapidly than continuous, monolithic, or block frozen ingredients. Use of individually quick frozen ingredients also reduces the amount of energy required to heat a particular combination of food ingredients to the appropriate serving temperature. That energy reduction is a result of at least the reduced required cooking time for individually quick frozen ingredients.

Where the individually quick frozen ingredients are combined with packaging of the type discussed and described herein, those individually quick frozen ingredients allow the hot food to become hot faster while the cold food remains colder due at least to the reduced time the overall package is exposed to microwave energy. Thus, the incorporation of individually quick frozen ingredients enhances the quality and temperature of the resulting heated meal. The improvement in cooking time for a microwavable meal according to the present invention using individually quick frozen ingredients has been found to be a reduction in cooking time in the range of about 15% to about 35%. For example, using portions of typical size in a microwavable heating tray according to this invention, where the ingredients are supplied in individually quick frozen form, provided a cooking time that was 1 minute and 15 seconds shorter than the cooking time when the ingredients were not supplied in individually quick frozen form. It is anticipated that the cooking time reduction may be less in applications where smaller food portions are employed, such as for example with diet control applications.

Use of individually quick frozen ingredients also improves the textural properties of the resulting food components. For example, pasta may be provided with an “al dente” texture. Again, the specific reasons for this improved characteristic are not fully understood at this time, but are believed to include the minimal moisture migration from component to component where the ingredients are in the individually quick frozen form. With the ability to control moisture migration through use of individually quick frozen ingredients, moisture levels of adjacent or juxtaposed ingredients may be independently selected. This characteristic is not available in conventional monolithic or block frozen components.

When a microwavable tray according to this disclosure has different frozen foods packaged in its various compartments as a microwavable serving for subsequent microwave heating, significant improvements and advantages result. For example, the microwavable serving product or package is a substantial improvement compared to prior art packages at least because a single heating step is used, in contrast to prior art products or packages where a first microwaving step is typically followed by a stirring step which, in turn, is typically followed by a second microwaving step. Accordingly, it is seen that the present invention provides a simple, one-step, microwave heating step to fully prepare the package for use, and the food ingredients for consumer consumption.

The microwavable product or package of this disclosure provides consistent, repeatable temperature in its various compartments. Moreover, those consistent, repeatable temperatures are not the same in all the compartments. The product or package yields optimal heating in each of the various compartments. Moreover, it should be appreciated that this disclosure is not limited to a microwavable product or package having any particular number of compartments. The concepts of this disclosure are applicable to microwavable products or packages having more or less than three compartments (e.g., one, two, three, four, etc.).

While several particular selections of food suitable for use in connection with the present invention have been described and discussed above, it should be appreciated by those skilled in the art that this invention is not limited to those foods. The generality of this invention is better understood when it is considered that a multiplicity of other food combinations may be used in the packaging. More particularly, suitable food combinations include, for example and without limitation: grilled chicken with steamed broccoli and hot fudge sundae; three cheese ziti with green beans and Italian ice; peppercorn beef with green beans and/or mushrooms and sorbet; turkey with mashed potatoes and pumpkin pie; BBQ chicken with baked beans and strawberry shortcake; peppercorn beef with green beans and/or mushrooms and key lime pie; Salisbury steak with macaroni and cheese and asparagus; meatloaf with mashed potatoes and green beans; slow roasted turkey with stuffing and cranberry sauce; rosemary chicken with mashed potatoes and broccoli; beef teriyaki with rice and pineapple; sesame chicken with rise and oranges; turkey with stuffing and cranberries; pancakes and maple syrup with strawberries; cheesy scramble having turkey sausage with mixed berries; egg omelet with hash brown potatoes and mixed fruit; oatmeal with blueberries; ham and cheese scrambled eggs with hash browns and cinnamon roll; three cheese egg omelet with turkey sausage and blueberry muffin; oatmeal with banana nut muffin and blueberries; Asian chicken salad; southwest chicken salad; BBQ chopped chicken salad; buffalo chicken salad; potatoes with broccoli, cheddar and bacon; potatoes with chicken, bacon and ranch dressing; potatoes with chili and sour cream; potatoes with tuna au gratin; sandwich with cole slaw; sandwich with fruit salad; sandwich with broccoli salad; sandwich with pasta salad; broccoli cheddar soup with turkey; tomato soup with whole grain cheese bread; chili with corn bread; chicken ranchero wrap with ranch dip; mini cheeseburger with ketchup; boneless chicken winds with blue cheese dip; chicken and cheese quesadilla with queso; chicken and cheese quesadilla with salsa; and other combinations of one food item and at least a second food item, where the first and second food items are desirably served at different temperatures.

Where, for example, one compartment includes a salad and another compartment includes a salad topping, the package may be heated so that the topping is heated or warmed so as to be dumped on or spread over the salad portion. Any such combination of foods from different compartments may be performed in the microwavable tray itself or in a separate dish, as desired.

In a preferred embodiment a three compartment tray is substantially square in shape with an triangle or Y shaped compartment divider. As described here, this provides foods at optimum eating temperatures and textures when heating in the microwave oven. For example, where the compartments contain a three cheese ziti, green beans, and ice cream respectively, after microwave heating, the ziti and green beans are at temperatures above 160° F. and the ice cream remains cold around 20° F. to 30° F. All three food components come out to their ideal texture and temperature in a one-step microwave cook preparation. For the ice cream sundae compartment, there are foil shields attached to that compartment in order to get the temperature of ice cream to be the coldest part of the meal.

For the cold temperature compartment, there is a foil shield present, preferably aluminum, on the base and side walls in order to deflect microwave energy from coming in thru the bottom or the sides of the compartment. Additionally, a foil lid stock material, again preferably aluminum, is sealed to the top flange surface of the cold food temperature compartment to deflect microwave energy from penetrating into the compartment from the top. The foil shields control the amount of energy absorbed by these food items in all three compartments. In this embodiment, the foil shields are present on base, side walls, and top of the compartment. However, in other embodiments, the foil shields could be present only on some of the surfaces of the compartment in order to control the amount of energy entering the cold food compartment. Additionally, the use of square or circle shaped apertures in the foil shields can be used in order to control the amount of microwave energy getting into the shielded compartment.

During microwave testing, there are several microwaves in the marketplace that contain removable metal racks. These microwaves are designed to cook multiple frozen meal products at once by placing one meal underneath the metal rack and another meal on-top of the metal rack. When a tray has a bottom aluminum foil shield, there is an increased potential for arcing between the foil shield attached to the tray and the metal rack. In testing, it was found that when the bottom foil shield is in contact with the rings of the metal rack, the potential exists for arcing to occur and produce a static discharge. Arcing can occur when there is a metal-air-metal gap less than 2 mm as well as when two close metal objects have different electric potentials. Therefore, when this tray is touching the metal rack, it can potentially arc because of the electric potentials of the aluminum foil and the steel of the removable rack as well as the metal-air-metal gap is less than 2 mm. Therefore, in order to minimize the potential for arcing within the microwave when the tray is placed on the metal rack, a piece of boardstock material, such as Solid Bleached Sulfate (SBS) boardstock, can be placed in-between the metal rack and the bottom foil shield. This piece of SBS material can be in the shape of the tray to eliminate the metal-air-metal gap that can produce arcing.

As described herein, the substantially oval design of the larger hot compartment (i.e. entrée compartment) helps the food item to uniformly absorbs microwave energy. The gradual radius of the larger compartment helps to prevent overheated corners. As also described herein, in the larger hot compartment of the tray, there is a convex protrusion base in the area of the food product that will not heat quickly. This design also separates the food from the glass turntable which helps prevent energy from the heated food from transferring into the glass plate.

The triangle or ‘Y” shaped divider structure design help provide structural support for the handling of the tray before and after cooking. Since triangles are a strong structural shape, the shape of this divider lends itself to increase its strength in both the length and width direction of the tray. When looking at a top view of the tray, the angle of the divider from the side wall of the tray toward the center of the tray, in one embodiment, is approximately 55 degrees.

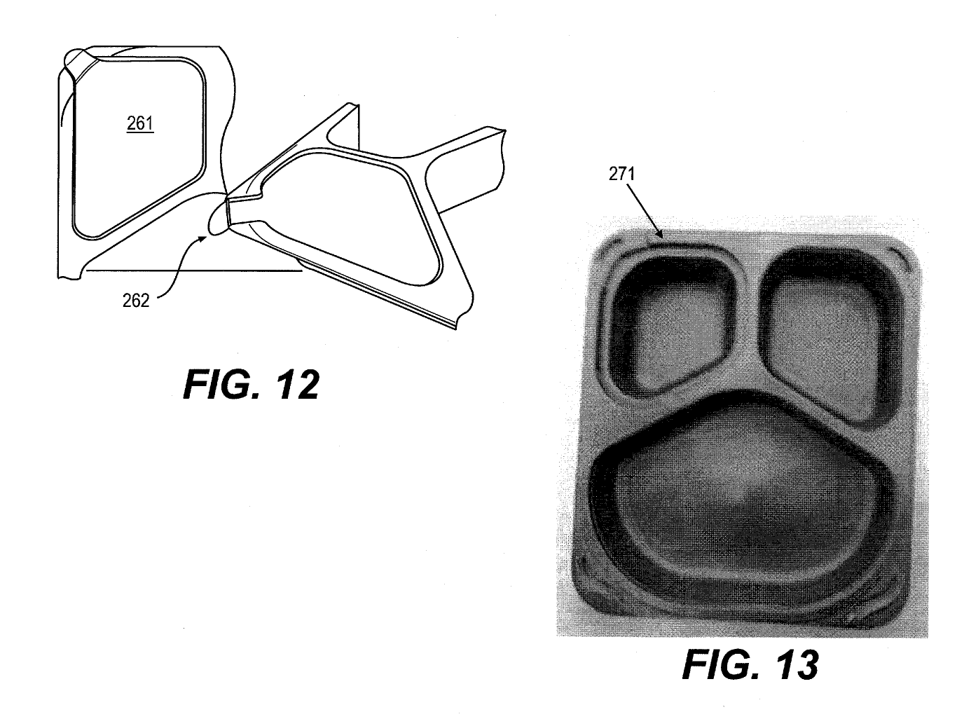

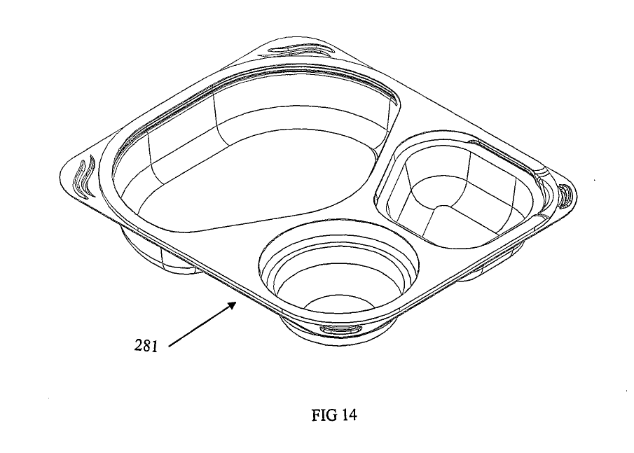

In one embodiment (see FIG. 13), there is a recessed sealing surface (271) on one of the shielded compartment portions of the tray specifically adapted to contain a food item. For quality assurance purposes, for example, this recessed surface design allows for that compartment to be sealed off before the tray is filled with other food items in the other compartments. A die-cut aluminum foil lid stock or polyester lid stock (261 in FIG. 12) can be sealed to this recessed surface. The recessed sealing surface should preferably be at least 5 millimeters (mm) in the width dimension to provide good (substantially airtight) sealing surface to that portion of the tray.

On the base structure of the tray described above (FIG. 12), there can be a pull tab (262) opening feature as part of the recessed sealing surface of the shielded compartment. In order to remove the foil lid stock off of the shielded compartment, there is a pull tab feature located on the handle that is adjacent to the shielded compartment. This can be a design feature in the base tray and a lid-stock design of the foil lid stock material. Regarding the base tray, the top outside tray flange is slightly recessed in the area next to the handle. The flange is recessed in this area to allow for the pull tab of the die-cut foil lid stock to sit there before opening. As part of this recessed flange surface design, there is a slight radius on the inside part of that tray flange so that during removal of the foil lid stock, the foil does not tear during the removal. The other part of this pull tab design is the die-cut foil lid stock. The die-cut foil lid stock has a round shape tab on one of the ends to make it easier for a consumer to grab onto it and pull it for removal.

In one embodiment, (see FIG. 13) on all four corners of the tray, there are handles to allow for an easier surface for consumers to hold the tray after taking it out of the microwave. These handles can have convex protrusion and concave ridges to act as a gripping surface for thumbs and fingers during handling.

There is typically an air gap existing between the top clear polyester polymeric film over-covering all three food compartments and sealed to the top tray flange area and the lid stock sealed on the recessed surface. This air gap prevents any moisture or heated air from entering the shielded compartment. In one embodiment, the shape of the foil shielded compartment is generally round to help allow the foil shield to conform to it. For example, using a 12 degree draft angle along with the radiuses of the compartment are better for the forming and assembling process. Tighter radiuses and steeper draft angles result in greater difficulty for forming and assembling the foil base structure. For example, tighter radius and steeper draft angle could result in tears in the foil forming process.

For ease of production, for quality assurance reasons there are various tray constructs that could lend themselves for a manufacturing this multi-temp/multi-texture food item. For example, with ice cream, yogurt and other food items, this compartment of the tray first could be filled first and sealed before filling the other two compartments with other food items. The desert/cold compartment is typically filled first for quality assurance reasons. The remaining trays are filled using conventional processes.

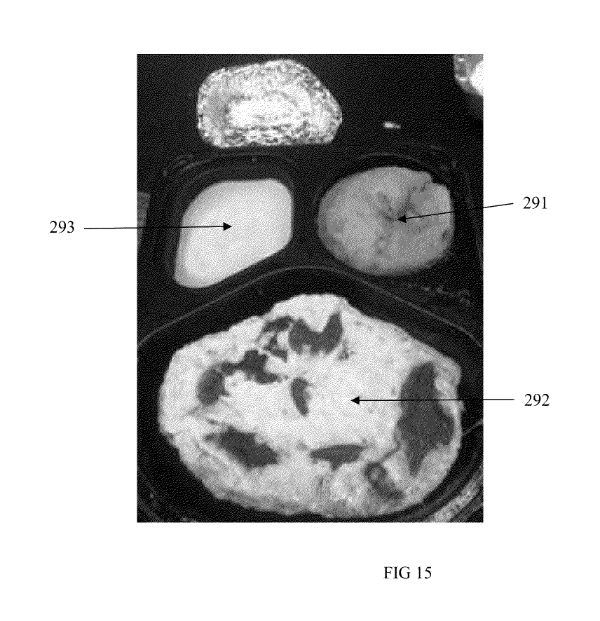

In another embodiment of this tray (see FIG. 14), the other (third) smaller compartment could also have a recessed surface. Additionally, the shape of the third compartment could be circular in shape (281) to help with uniform cooking in the microwave. In this embodiment, an egg based mixture, for example, is placed in the larger compartment, a muffin batter mixture, for example, is placed in the circular recessed compartment, and a yogurt/fruit mixture, for example, is placed in a trapezoidal shaped recessed surface compartment. The trapezoidal shape compartment has a foil pan shield attached to the bottom of the compartment to block microwave energy from going into the yogurt compartment. The foil pan is used on the compartment to make sure the temperature of the yogurt is around 30° F. to 45° F. after cooking in the microwave. The recessed surface in the circular compartment shape is designed to help with the cooking performance of the batter food mixture in that compartment. The idea of the recessed surface is to create a “muffin-top” look to the muffin batter. The muffin batter in this compartment is raw frozen batter and rises in the microwave during cooking. When the muffin batter rises in the microwave (see FIG. 15), the muffin (291) will expand to the shape of the compartment and that recessed surface. In the larger compartment, there will be an egg base mixture that forms a frittata (292). The frittata is cooked from a frozen liquid egg base and cooks once in the compartment. The larger compartment has the convex domed bottom feature to help with its even cooking in the microwave. The convex dome bottom helps prevent overcooking of the frittata edges. The third compartment contains the yogurt (293).

There are also several designs and manufacturing options for providing shielding to the microwave (at least partially) shielded compartment. For example, the foil can be attached to the outside of the tray compartment containing the recessed sealing surface. The bottom and side foil shielding of the compartment is adhered onto the outside of the compartment. It is adhered to the bottom surface via conventional microwave safe adhesive (for example, available from 3M. The recessed sealing surface provides an area that can be used to seal the food items with a foil lid stock or polymeric lid stock before depositing the food items in the other compartments. The lid-stock is die-cut and can have a pull tab feature at the end to facilitate opening. The other food items are filled into their respective compartments after the shielding compartment is sealed. Manufacturing Filling Procedure: Deposit Desert, seal desert compartment with foil lid stock, deposit food items into tray, apply poly lid film, carton, and then case-pack.

While the square (e.g., 7¾ inch on a side) design described herein has many advantages, it is particularly advantageous for shelf space store needs and transporting on pallets. But even with this design, the trays described herein still provide uniform heating in each individual compartment (one heating step, no stir, uniform heating, no overcooked edges, or raw center). These tray designs also provide improved handling stability, from buckling for example. As also described herein, the rounded edges (lack of sharp corners) helps in even heating, which is particularly challenging when utilizing a substantially square design.

It should also be noted that the density of the particular food item, the thickness of food item in the tray compartment, the weight of the food item in the tray compartment, etc., all influence the amount of heating and amount of shielding needed, for uniform heating in each compartment in a one tray heating process.

In this specification, the word “about” is often used in connection with a numerical value to indicate that mathematical precision of such value is not intended. Accordingly, it is intended that where “about” is used with a numerical value, a tolerance of 10% is contemplated for that numerical value.

Moreover, when the words “generally” and “substantially” are used in connection with geometric shapes, it is intended that precision of the geometric shape is not required but that latitude for the shape is within the scope of the disclosure. When used with geometric terms, the words “generally” and “substantially” are intended to encompass not only features which meet the strict definitions but also features which fairly approximate the strict definitions. In this connection, the term “rounded” is intended to also include configurations comprising two or more substantially straight line segments describing the “rounded” feature.

While the foregoing describes in detail a microwave heating tray, methods of making the tray, and methods of use, it will be apparent to one skilled in the art that various changes and modifications may be made to the disclosed tray and methods and further that equivalents may be employed, which do not materially depart from the spirit and scope of the invention. Accordingly, all such changes, modifications, and equivalents that fall within the spirit and scope of the invention as defined by the appended claims are intended to be encompassed thereby.

1. A microwave heating support comprising:
a tray having a smoothly contoured, substantially square peripheral shape, substantially free of sharp corners, having a Y shaped compartment divider, and formed of a microwave safe plastic or paper material, said tray including:
a first integral compartment defined by at least one sidewall and an upwardly convex bottom;
a second integral compartment defined by at least one sidewall and a generally planar bottom,
a third integral compartment defined by at least one sidewall and a generally planar bottom,
wherein the integral compartments are spaced apart from each other by a distance sufficient to provide thermal insulation between the compartments, the shape and spacing of the compartments resulting in uniform heating within each individual compartment, and the Y shaped compartment divider providing flex stability to the tray.

2. The microwave heating support of claim 1, wherein at least one of the compartments has a recessed sealing surface.

3. The microwave heating support of claim 1, wherein at least one of the compartments further includes a microwave energy limiting structure.

4. The microwave heating support of claim 3, wherein the microwave energy limiting structure includes a material selected from the group consisting of foil, microwave absorbing material, microwave transmitting material, microwave reflecting material, and combinations thereof.

5. The microwave heating support of claim 3, wherein the microwave energy limiting structure includes at least one opening.

6. The microwave heating support of claim 1, wherein the first integral compartment contains a first quantity of food, the second integral compartment contains a second quantity of food, and the third integral compartment contains a third quantity of food.

7. The microwave heating support of claim 6, wherein the first quantity of food, the second quantity of food and the third quantity of food have different densities and/or heating characteristics.

8. The microwave heating support of claim 7, wherein at least one of the first quantity of food, the second quantity of food and the third quantity of food is an individually quick frozen food item.

9. The microwave heating support of claim 2, wherein at least one food item is contained in the recessed sealing surface containing compartment.

10. The microwave heating support of claim 9, wherein the recessed sealing surface containing compartment is sealed with a metal foil or plastic lid.

11. The microwave heating support of claim 10, wherein the lid contains a pull-tab.

12. The microwave heating support of claim 10, wherein the lid is aluminum foil or polyester lid stock.

13. The microwave heating support of claim 6, wherein the upwardly convex bottom has a domed central portion and a lower, outer edge and the food located at the lower, outer edge is thicker than the food located at the domed central portion.

14. The microwave heating support of claim 13, wherein the domed central portion is offset from the lower, outer edge by about 0.1 inch to about 1.0 inch.

15. The microwave heating support of claim 1, wherein adjacent portions of the sidewalls of the compartments diverge in a downward direction.

16. The microwave heating support of claim 3, wherein the microwave energy limiting structure is removable.

17. The microwave heating support of claim 6, further including lidding material covering at least the first, second and third compartments, and being sealed to the tray so as to substantially isolate the first, second and third compartments from one another.

18. The microwave heating support of claim 17, wherein the lidding material is sealed to the tray substantially along the smoothly contoured peripheral shape thereof and offset from the periphery toward the center of the container.

19. A method of packaging multiple foods for microwave heating to different temperatures comprising the steps of providing a microwavable plastic or paper tray having a substantially square peripheral shape, substantially free of sharp internal or external corners, having a Y shaped compartment divider, said tray including a first integral compartment defined by at least one sidewall and a generally planar bottom; a second integral compartment defined by at least one sidewall and an upwardly convex bottom, and a third integral compartment defined by at least one sidewall and a generally planar bottom, wherein the integral compartments are spaced apart from each other by a distance sufficient to provide thermal insulation between the compartments, the shape and spacing of the compartments resulting in uniform heating within each individual compartment, and the Y shaped compartment divider providing flex stability to the tray:
placing a first food in the first integral compartment of the tray so that upon exposure to microwave energy for a predetermined time period the temperature of the first food reaches a corresponding first temperature;
placing a second food in the second integral compartment of the tray such that the second food has a greater thickness at peripheral portions thereof than at central portions thereof, so that upon exposure to microwave energy for a predetermined time period the temperature of the second food reaches a corresponding second temperature which is different than the first temperature; and
placing a third food in the third integral compartment of the tray so that upon exposure to microwave energy for a predetermined time period the temperature of the third food reaches a corresponding third temperature which is different than the first temperature,
at least partially covering at least one of the first, second and third compartments with a microwave modulating structure, so that upon exposure to the microwave energy for the predetermined time period the temperature of the second and third foods reach corresponding second and third temperatures which are different than the first temperature; and
covering at least one of the first, second and third compartments with a substantially microwave transparent structure.

20. The method of claim 19, wherein the microwave modulating structure reduces the microwave energy entering the compartment by at least about 25%.

21. The method of claim 19, wherein at least one of the first, second and third foods is a quick frozen food item.

22. The method of claim 19, wherein at least one of the compartments has a recessed sealing surface.

23. The method of claim 22, wherein the recessed sealing surface containing compartment is sealed with a metal foil or plastic lid.

24. The method of claim 23, wherein the lid contains a pull-tab.

25. The method of claim 23, wherein the lid is aluminum foil or polyester lid stock.
